(19) United States
(12) Patent Application Publication
(10) Pub. No.: US 2022/0300627 A1
(43) Pub. Date: Sep. 22, 2022

(54) Method and System for Access Authorization Using Flows and Circulation on Graphs

(71) Applicant: Authomize LTD., Tel Aviv (IL)

(72) Inventors: Gal DISKIN, Tel Aviv (IL); Avi AMINOV, Givat Shmuel (IL)

(21) Appl. No.: 17/700,583

(22) Filed: Mar. 22, 2022

Related U.S. Application Data
(60) Provisional application No. 63/164,334, filed on Mar. 22, 2021.

(51) Int. Cl. G06F 21/60; G06F 16/901; G06F 21/45

(52) U.S. Cl. CPC G06F 21/604; G06F 16/9024; G06F 21/45

(57) ABSTRACT

Based on received first criteria, computerized methods and systems select from one or more first set of computerized directories, that store information about subjects, resources, actions, and privileges associated with an organization, subsets of each of: subjects, groups of subjects, privileges, resources, groups of resources, and actions. Based on received second criteria, the computerized methods and systems select from one or more second set of directories a subset of activity logs that store information related to activities performed by subjects on resources. The computerized methods and systems generate a relationship graph using the selected subsets of subjects, groups of subjects, privileges, resources, groups of resources, actions, and activity logs, and apply a set of circulation problem constraints to the relationship graph to produce a constrained relationship graph. The computerized methods and systems enable the organization to modify a security posture based on the constrained relationship graph.

### CROSS-REFERENCE TO RELATED APPLICATIONS

This application claims priority from U.S. Provisional Patent Application No. 63/164,334, filed Mar. 22, 2021, whose disclosure is incorporated by reference in its entirety herein.

### TECHNICAL FIELD

The present invention relates to information security.

### BACKGROUND OF THE INVENTION

Organizations, also referred to as enterprises, employ access authorization and information security measures, often in the form of access control rules and policies, to ensure that information (for example pertaining to resources or groups of resources) associated with the organization is secure, and can only have actions performed thereon by specific entities (for example specific subjects or users) associated with the organization. As the amount of information and entities to be controlled by an organization grows, generating and/or providing rules and policies that effectively ensure security can become difficult. In addition, undermanagement or mismanagement of access control rules and/or policies can lead to security vulnerabilities in the organization, decreasing the overall security posture of the organization.

### SUMMARY OF THE INVENTION

Aspects of the present invention provide methods and systems for access authorization utilizing graphs in order to improve the security posture of an organization.

Embodiments of the present invention are directed to a computer-implemented method. The computer-implemented method comprises: based on received first criteria, selecting from one or more first set of computerized directories that store information about subjects, resources, actions, and privileges associated with an organization, subsets of each of: i) subjects, ii) groups of subjects, iii) privileges, iv) resources, v) groups of resources, and vi) actions; based on received second criteria, selecting from one or more second set of directories a subset of activity logs that store information related to activities performed by subjects on resources; generating a relationship graph using the selected subsets of i) subjects, ii) groups of subjects, iii) privileges, iv) resources, v) groups of resources, vi) actions, and vii) activity logs; and applying a set of circulation problem constraints to the relationship graph to produce a constrained relationship graph so as to enable the organization to modify a security posture based on the constrained relationship graph.

Optionally, the computer-implemented method further comprises: identifying in the constrained relationship graph one or more sets of edges that have at least one of the following characteristics: i) are critical edges, ii) are non-critical edges, iii) have a high aggregate flow, iv) have a low aggregate flow, v) have a high flow, or vi) have a low flow.

Optionally, the computer-implemented method further comprises: applying a community detection algorithm to the constrained relationship graph to identify one or more communities of similar nodes that share one or more edges of the constrained relationship graph with a same set of nodes of the constrained relationship graph, for each identified community of the identified one or more communities, the nodes in the identified community are all of a same node type that is selected from the group consisting of: subjects, groups of subjects, resources, and groups of resources; and outputting the identified one or more communities.

Optionally, the computer-implemented method further comprises: applying a centrality measurement algorithm to the constrained relationship graph to identify one or more nodes as central nodes based on a number of edges leading to or from the identified one or more nodes, and the identified one or more central nodes includes one or more: resources, groups of resources, subjects, or groups of subjects; and outputting the identified one or more central nodes.

Optionally, the computer-implemented method further comprises: filtering out edges of the constrained relationship graph that have an aggregated flow that is below a preconfigured threshold to obtain a filtered graph.

Optionally, the computer-implemented method further comprises: applying a community detection algorithm to the filtered graph to identify one or more communities of similar nodes that share one or more edges of the filtered graph with a same set of nodes of the filtered graph, for each identified community of the identified one or more communities, the nodes in the identified community are all of a same node type that is selected from the group consisting of: subjects, groups of subjects, resources, and groups of resources; and outputting the identified one or more communities.

Optionally, the computer-implemented method further comprises: applying a centrality measurement algorithm to the filtered graph to identify one or more nodes as central nodes based on a number of edges leading to or from the identified one or more nodes, and the identified one or more central nodes includes one or more: resources, groups of resources, subjects, or groups of subjects; and outputting the identified one or more central nodes.

Embodiments of the present invention are directed to a computer system. The computer system comprises: a non-transitory computer readable storage medium for storing computer components; and a computerized processor for executing the computer components. The computer components comprise: a first selection module for selecting, from one or more first set of computerized directories that store information about subjects, resources, actions, and privileges associated with an organization, subsets of each of: i) subjects, ii) groups of subjects, iii) privileges, iv) resources, v) groups of resources, and vi) actions, and the first selection module performs the selecting based on received first criteria, a second selection module for selecting from one or more second set of directories, and based on received second criteria, a subset of activity logs that store information related to activities performed by subjects on resources, a graph generation module for generating a relationship graph using the selected subsets of i) subjects, ii) groups of subjects, iii) privileges, iv) resources, v) groups of resources, vi) actions, and vii) activity logs, and a constraint application module for applying a set of circulation problem constraints to the relationship graph to produce a constrained relationship graph so as to enable the organization to modify a security posture based on the constrained relationship graph

Optionally, the computer components further comprise: an identification module for identifying in the constrained relationship graph one or more sets of edges that have at least one of the following characteristics: i) are critical edges, ii) are non-critical edges, iii) have a high aggregate flow, iv) have a low aggregate flow, v) have a high flow, or vi) have a low flow.

Optionally, the computer components further comprise: a community detection module for: applying a community detection algorithm to the constrained relationship graph to identify one or more communities of similar nodes that share one or more edges of the constrained relationship graph with a same set of nodes of the constrained relationship graph, for each identified community of the identified one or more communities, the nodes in the identified community are all of a same node type that is selected from the group consisting of: subjects, groups of subjects, resources, and groups of resources, and providing the identified one or more communities for output.

Optionally, the computer components further comprise: a centrality measurement module for: applying a centrality measurement algorithm to the constrained relationship graph to identify one or more nodes as central nodes based on a number of edges leading to or from the identified one or more nodes, and the identified one or more central nodes includes one or more: resources, groups of resources, subjects, or groups of subjects, and providing the identified one or more central nodes as output.

Optionally, the computer components further comprise: a filter module for filtering out edges of the constrained relationship graph that have an aggregated flow that is below a preconfigured threshold to obtain a filtered graph

Optionally, the computer components further comprise: a community detection module for: applying a community detection algorithm to the filtered graph to identify one or more communities of similar nodes that share one or more edges of the filtered graph with a same set of nodes of the filtered graph, for each identified community of the identified one or more communities, the nodes in the identified community are all of a same node type that is selected from the group consisting of: subjects, groups of subjects, resources, and groups of resources, and providing the identified one or more communities for output.

Optionally, the computer components further comprise: a centrality measurement module for: applying a centrality measurement algorithm to the filtered graph to identify one or more nodes as central nodes based on a number of edges leading to or from the identified one or more nodes, and the identified one or more central nodes includes one or more: resources, groups of resources, subjects, or groups of subjects, and providing the identified one or more central nodes as output.

Embodiments of the present invention are directed to a computer usable non-transitory storage medium having a computer program embodied thereon for causing a suitable programmed system to perform the following steps when such program is executed on the system. The steps comprise: based on received first criteria, selecting from one or more first set of computerized directories that store information about subjects, resources, actions, and privileges associated with an organization, subsets of each of: i) subjects, ii) groups of subjects, iii) privileges, iv) resources, v) groups of resources, and vi) actions; based on received second criteria, selecting from one or more second set of directories a subset of activity logs that store information related to activities performed by subjects on resources; generating a relationship graph using the selected subsets of i) subjects, ii) groups of subjects, iii) privileges, iv) resources, v) groups of resources, vi) actions, and vii) activity logs; and applying a set of circulation problem constraints to the relationship graph to produce a constrained relationship graph so as to enable the organization to modify a security posture based on the constrained relationship graph.

Optionally, the steps further comprise: identifying in the constrained relationship graph one or more sets of edges that have at least one of the following characteristics: i) are critical edges, ii) are non-critical edges, iii) have a high aggregate flow, iv) have a low aggregate flow, v) have a high flow, or vi) have a low flow.

Optionally, the steps further comprise: applying a community detection algorithm to the constrained relationship graph to identify one or more communities of similar nodes that share one or more edges of the constrained relationship graph with a same set of nodes of the constrained relationship graph, for each identified community of the identified one or more communities, the nodes in the identified community are all of a same node type that is selected from the group consisting of: subjects, groups of subjects, resources, and groups of resources; and outputting the identified one or more communities.

Optionally, the steps further comprise: applying a centrality measurement algorithm to the constrained relationship graph to identify one or more nodes as central nodes based on a number of edges leading to or from the identified one or more nodes, and the identified one or more central nodes includes one or more: resources, groups of resources, subjects, or groups of subjects; and outputting the identified one or more central nodes.

Optionally, the steps further comprise: filtering out edges of the constrained relationship graph that have an aggregated flow that is below a preconfigured threshold to obtain a filtered graph.

Optionally, the steps further comprise: applying a community detection algorithm to the filtered graph to identify one or more communities of similar nodes that share one or more edges of the filtered graph with a same set of nodes of the filtered graph, for each identified community of the identified one or more communities, the nodes in the identified community are all of a same node type that is selected from the group consisting of: subjects, groups of subjects, resources, and groups of resources; and outputting the identified one or more communities.

Optionally, the steps further comprise: applying a centrality measurement algorithm to the filtered graph to identify one or more nodes as central nodes based on a number of edges leading to or from the identified one or more nodes, and the identified one or more central nodes includes one or more: resources, groups of resources, subjects, or groups of subjects; and outputting the identified one or more central nodes.

Throughout this document, reference is made to data or information pertaining to, or descriptive of, subjects, groups of subjects, resources, groups of resources, actions, privileges, and attributes thereof. This data/information is in the form of data objects that can be read from and written to computerized memory/storage, and manipulated by performing various operations on such data objects by computerized processors or similar such devices or apparatus. As will be discussed, these data objects can be stored in one or more computerized directories.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of the architecture of an exemplary system embodying the present disclosure;

FIG. 2 is a diagram illustrating an example environment in which a system according to an embodiment of the present disclosure can be deployed;

FIG. 3 is a diagram of an exemplary graph that can be generated by the system and a method according to embodiments of the present disclosure;

FIG. 4 is a flow diagram illustrating a process for generating and using graphs in order modify, and in particular improve, the security posture of an organization, according to an embodiment of the present disclosure.

### DESCRIPTION OF THE PREFERRED EMBODIMENTS

Embodiments of the present invention provide access authorization methods and systems.

The principles and operation of the methods and systems according to the present invention may be better understood with reference to the drawings accompanying the description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

As will be appreciated by one skilled in the art, aspects of the present disclosure may be embodied as a system, method, or a computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit”, “module”, or “system. Additionally, a “module” includes a component for storing instructions (e.g., machine readable instructions) for performing a process, and including or associated with processors for executing the instructions. Furthermore, aspects of the present disclosure may take the form of a computer program product embodied in one or more non-transitory computer readable (storage) medium(s) having computer readable program code embodied thereon.

As will become apparent to those skilled in the art, the embodiments of the present disclosure provide improvements in computer technology, in particular improvements in computer security policy and/or computer-based access control policy employed by an organization/enterprise, by generating and utilizing specific types of constrained graphs. The embodiments of the present disclosure solve a particular problem of how to manage complex security policies and/or access control policies by utilizing the aforementioned constrained graphs to identify redundancy in such policies and to generalize such policies. This directly leads to an improvement in the security posture of the organization/enterprise, resulting in reduced security vulnerabilities in the organization.

By way of introduction, the following terms are used throughout the present document: “subject”, “action”, “resource”, “attribute”, “group”, and “privilege”. These terms are commonly used in the art of information security and access control. A brief definition and examples of the aforementioned terms will now be provided before describing embodiments of the present disclosure in detail.

A “subject” generally refers to the entity (who or what) that is requesting to perform, or that performs, an action. A subject can be a user (e.g., a person that is a member of the organization such as an employee, a person that is associated with the organization such as an external contractor, consultant, or customer/client) or an automated agent (e.g., a computer).

An “action” generally refers to an operation a subject would like to perform, or to an operation that a subject actually performs. Examples of actions include reading or writing to a file stored on a computer system, retrieving data from a database, actuating an electronic access point (e.g., electronic door/gate) to grant physical access (e.g., open or close), transferring money via electronic transfer, etc.

A “resource” generally refers to the information or object (electronic information or electronic object) that will be, or that is, impacted by the aforementioned action. This could be, for example, a computer or server system that stores files, a database table, an electronic access point (door or gate) that provides access to a building owned, operated or otherwise associated with the organization/enterprise, etc. Resources are also referred to as objects or assets.

Each of subjects, actions, and resources can be associated with various “attributes” which describe different features of the subjects, actions, and resources. For example, a server computer resource could be associated with a location attribute that represents, for example, the data center in which the server computer is located. As another example, a user subject could be associated with a salary attribute, an identification number attribute (e.g., tax ID (e.g., social security number), employee ID, etc.), and a birthdate attribute. As yet another example, an open-file action could be associated with a type attribute that indicates that the action is a file system type of action.

Subjects, resources, and actions can each be grouped to form a respective “group”. Specifically, subjects, resources, and actions can each be grouped to form groups of subjects, groups of resources, and groups of actions, respectively. A subject, resource, or action can be an explicit member of a group, for example by having the group point to that element (subject, resource, action) by name or a unique identifier. A subject, resource, or action can also be an implicit member of a group, for example by the group being defined as a set of elements having a certain attribute. For example, a group of subjects could be defined to contain all subjects having a location attribute of Oshkosh, Wis.

A “privilege” (also referred to in certain situations as an “entitlement”) defines an association between: 1) a first set of one or more subjects or groups of subjects, 2) a second set of one or more actions or groups of actions, and 3) a third set of one or more resources or groups of resources. A “privilege” generally designates that “subjects” (or groups thereof) within the first set are allowed to perform any of the “actions” (or groups thereof) in the second set on any of the “resources” (or groups thereof) in the third set. A privilege could be associated with additional attributes which may impose additional conditions for the actions to be allowed. For example, a privilege could be associated with a time-of-day attribute (e.g., 09:00 to 17:00) which restricts privilege to the specified time-of-day.

Role-Based Access Control (RBAC) and Attribute-Based Access Control (ABAC) are both examples of frameworks that handle subjects, actions, and resources. Under such frameworks, privileges can be referred to as roles, policies, access control policies, or rules, depending on the context.

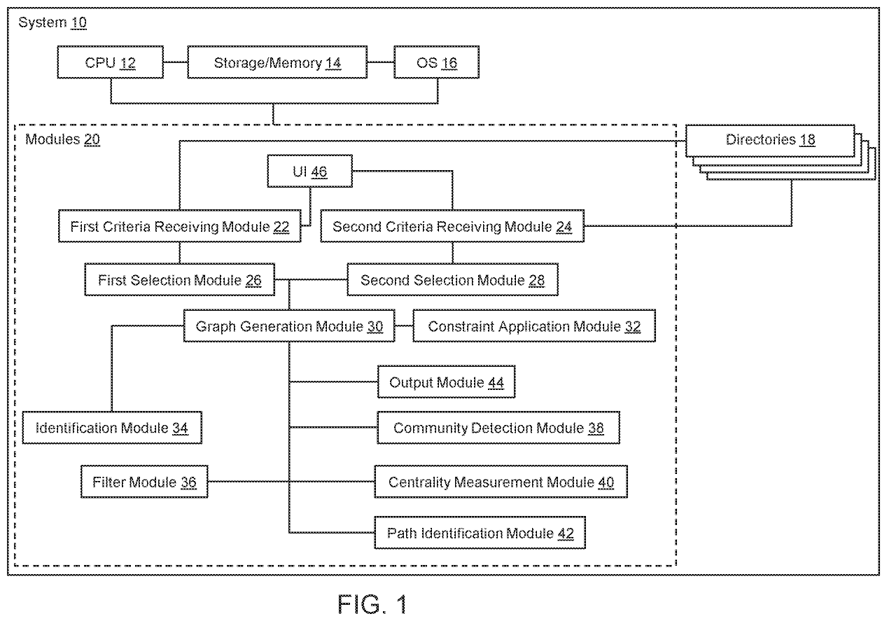

Bearing the above in mind, attention is now directed to FIG. 1 which illustrates an exemplary system 10 according to embodiments of the present disclosure as an architecture. The system 10 provides logic and logic functions, and is generally configured to receive input including information/data from one or more directories 18, and to perform various logic and logic functions based upon the received input.

The system 10 includes a central processing unit (CPU) 12 formed from one or more processors. The processors can, for example, be conventional processors, such as those used in servers, computers, and other computerized devices. For example, the processors may include x86 Processors from AMD and Intel, Xeon® and Pentium® processors from Intel, as well as any combinations thereof. However, the processors may include or be linked to special purpose processors in order to perform logic and logic functions associated with the access authorization methods of the embodiments disclosed herein.

The CPU 12 is electronically coupled (connected) to a storage/memory 14 for storing machine executable instructions, executable by the CPU 12, for performing the processes of the system 10, as will be detailed in subsequent sections of the present disclosure. The storage/memory 14, although shown as a single component for representative purposes, may be multiple components. Preferably at least one of the components of the storage/memory 14 is in the form of a non-transitory computer readable storage medium which stores computer components. The CPU 12 is also electronically coupled (connected), either directly or indirectly, to various modules 20 (computer components) that are configured to perform the various logic functions of the present disclosure. The CPU 12 is further electronically coupled (connected) to an operating system (OS) 16 that may load machine executable instructions, stored in the storage/memory 14, for execution by the CPU 12. The OS 16 may include any of the conventional computer operating systems, such as those available from Microsoft of Redmond Wash., commercially available as Windows® OS, such as Windows® 10, Windows® 7, MAC OS from Apple of Cupertino, Calif., or Linux, or may include real-time operating systems.

The aforementioned modules 20 are part of, or communicatively coupled to, the system 10, and are configured with instructions to perform the various logic functions of the disclosed embodiments. Typically, the system 10 includes software, software routines, computer program code, micro-code, computer program code segments and the like, embodied, for example, in modules or computer components (exemplarily illustrated as computer modules 20). The computer modules 20, as computer components, are stored in a non-transitory computer readable storage medium, which is preferably one of the components of the storage/memory 14 or another non-transitory computer readable storage medium electronically coupled to the CPU 12, such that the machine executable instructions stored in the computer modules 20 can be loaded and executed by the CPU 12.

In certain embodiments, the computer modules 20 include first and second criteria receiving modules 22, 24, first and second selection modules 26, 28, a graph generation module 30, a constraint application module 32, an identification module 34, a filter module 36, a community detection module 38, a centrality measurement module 40, a path identification module 42, an output module 44, and a user interface (UI) 46.

With continued reference to FIG. 1, the system 10 uses one or more directories 18 which can store data/information about subjects, resources, actions, and privileges. The directories 18 can also store data/information about attributes describing different features of subjects, resources, and actions, as well as groups of subjects, groups of resources, and groups of actions. As discussed above, this stored data/information are data objects.

In the illustrated embodiment, the directories 18 are part of the system 10, however in other embodiments the directories 18 are external to the system 10 and are communicatively coupled to components of the system 10 through an application programming interface (API) or a network protocol. In fact, according to certain embodiments of the present disclosure, any or all of the computer modules 20 can be connected to each other via one or more networks.

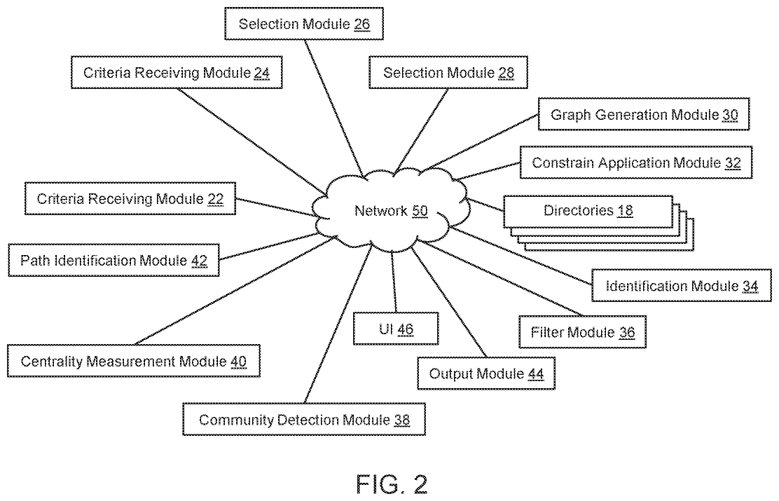

FIG. 2 illustrates an example environment in which a system according to an embodiment of the present disclosure can be deployed, in which the directories 18 are communicatively coupled to the computer modules 20 of the system 10 via network 50, which may be formed of one or more communication networks, including for example, the Internet, cellular networks, wide area, public, and local networks. In one non-limiting example, one or more of the external directories 18 is an LDAP directory, i.e., a directory that operates according to lightweight directory access protocol (LDAP), such as Active Directory developed by Microsoft. In another example, when a set of resources is managed by an organization in a public cloud environment such as in Amazon Web Services (AWS)— available from Amazon of Seattle Wash. — or Microsoft Azure, the information stored in the directory 18 is normally accessed through an API using a network protocol. Another example of such a directory 18 could be a database. Yet another example of such a directory could be a file system or an object storage system.

It should be appreciated that the information about the subjects and resources stored in these directories 18 could include various attributes related to the subjects and resources which could represent the relationship between these resources. For example, an Active Directory could store information related to the employees of an organization including employee job title, organization affiliation, identity of employee's manager, and so on. A public cloud-based directory could store information on virtual machine instances used by an organization. Such virtual machine instances could be regarded as resources but could also be regarded as subjects in case the virtual machine instances need to access or operate on other resources. For each such virtual machine instance, the directory could store additional attributes such as the type of software installed on these instances as well as the virtual machine instance location within the virtual network. In many cases, the directories 18 could store information about the groups to which the subjects and resources may belong.

One or more of the directories 18 also store information related to activities carried out by subjects on resources. This information can be stored, for example, in the form of activity logs. Within the context of this document, the term “activity log” generally refers to any data object that stores information related to activities carried out by subjects on resources.

It is noted that different directories 18 could be used to store different data/information and that the information stored in different directories could be disjoint, be identical, or partially overlap. For example, the set of directories 18 that store the activity logs can be the same set of directories 18 that store data/information about subjects, resources, actions, privileges, attributes, and groups of subjects, groups of resources, and groups of actions, or can be a different set of directories.

Activity logs are typically generated when a subject performs an action on a resource. An activity log can be generated by the subject that performs the action, by the resource on which the action is performed, or by any other machine or entity that is aware of the activity, such as, for example, a computer hosting the subject or the resource, or an electronic device, such as a network device or video camera, that monitors the activity.

Typically, a generated activity log identifies the subject, the action, and the resource associated with the activity, and also preferably includes additional information such as, for example, time information including one or more timestamps that represent the time (or time interval/range) at which the activity occurred, the electronic device that generated (or issued) the activity log, or any other additional technical parameters or data.

In certain embodiments, the activity log is stored in a directory 18 that is physically located on the electronic device that generated the activity log. In other embodiments, the activity log is transmitted/sent to a remote directory (remote from the log-generating electronic device). Various protocols can be used for transmitting activity logs to remote directories, including, for example, Simple Network Management Protocol (SNMP), Syslog, Hypertext Transfer Protocol (HHTP), HTTP Secure (HTTPS), Transport Layer Security (TLS), Secure Copy Protocol (SCP), and the like.

Each activity log can be stored in various file formats, including, for example, Common Log Format (CLF), Common Event Format (CEF), Comma-Separated Values (CSV) and its variants, and the like.

It is a particular feature of embodiments of the present disclosure to generate and use a directed graph that represents the relationship between subjects, activities, and resources, in order to improve the security posture of the organization, as will be described in further detail below.

In general, a graph is a data structure (i.e., a computer readable data object) that consists of a set of nodes {N₁, N₂, . . . , Nₖ} in which some pairs of the nodes are in some sense related. The relationship between each related pair of nodes is referred to as an edge (which is a direct connection between the related pair of nodes). In a directed graph, an edge e has an associated direction. To represent this direction, the pair of related nodes, say N₁ and N₂, are often referred to as the source node and the destination node, respectively, and the edge e is said to be the edge from the source node to the destination node.

The graph generation module 30 functions to generate a directed graph that represents the relationship between subjects, activities, and resources. The graph generation module 30 generates the directed graph based on the following two general sets of information: 1) information in selected subsets of the subjects, resources, actions, groups of subjects, groups of resources, groups of actions, and privileges (that are stored in one or more of the directories 18), and 2) information in a selected subset of activity logs (that are also stored in one or more of the directories 18).

Within the context of this document, the term “subset” encompasses both a proper subset of a set, as well as the entire set.

In preferred embodiments, the first selection module 26 functions to select the aforementioned subsets of subjects, resources, actions, groups of subjects, groups of resources, groups of actions, and privileges. The first selection module 26 further functions to provide the selected subsets as input to the graph generation module 30.

The first selection module 26 may select the subsets of subjects, resources, actions, groups of subjects, groups of resources, groups of actions, and privileges based on (i.e., in accordance with) various selection criteria. In certain preferred embodiments, the first criteria receiving module 22 functions to receive a set of first criteria for selecting the subsets, and provides the set of first criteria to the first selection module 26 such that the first selection module 26 uses the first (selection) criteria to select the subsets. In one non-limiting example, the first criteria include any attributes associated with the resources, and/or actions, and/or groups of subjects, and/or groups of resources, and/or groups of actions, and/or privileges, such that the first selection module 26 selects the aforementioned subsets based on the aforementioned attributes.

The second selection module 28 functions to select the aforementioned subset of activity logs, and further functions to provide the selected subset of activity logs as input to the graph generation module 30.

Similar to the first selection module 26, the second selection module 28 may select the subset of activity logs based on (i.e., in accordance with) various selection criteria. In certain preferred embodiments, the second criteria receiving module 24 functions to receive a set of second criteria for selecting the subset of activity logs, and provides the set of second criteria to the second selection module 26 such that the second selection module 26 uses the second (selection) criteria to select the subset. A non-exhaustive list of non-limiting examples of second criteria include: 1) selecting activity logs based on the time at which the activities associated with the activity log occurred, such as all recent activities (where “recent” can be defined as occurring within a certain period of past time), activities that occurred at or during a specified time interval, or activities that occurred during certain recurring time intervals (e.g., weekdays, weekends, office (working) hours, etc.), 2) selecting only activity logs whose activities relate to a specified set of actions, 3) selecting only activity logs that are stored in a specified set of directories, 4) selecting activity logs generated by a specific set of activity loggers.

It should be appreciated that many other criteria can be used to select the subsets of subjects, resources, actions, groups of subjects, groups of resources, groups of actions, and privileges, and to select the subset of activity logs.

In certain embodiments, the UI 46 functions to provide the first selection criteria and/or the second selection criteria to the relevant criteria selection modules 22, 24. The UI 46 generally encompasses any type of interface that can be used, for example by an administrator of the system 10, to provide the aforementioned selection criteria, including, for example, conventional user-interfaces, such as human-machine interfaces (which may include graphical user interfaces), Application Program Interfaces (APIs), network protocols, and the like. In certain embodiments, the UI 46 receives input, indicative of the selection criteria, via one or more computer input devices (e.g., keyboard, mouse, microphone, etc.), and provides the received selection criteria to the criteria selection module (or modules). In other embodiments, the UI 46 provides the selected criteria directly to the selection modules 26, 28. In yet other embodiments, the selection modules 26, 28 provide interface functionality for receiving selection criteria without necessitating use of the UI 46.

As mentioned above, the graph generation module 30 generates a directed graph based on the selected subset of activity logs and the selected subsets of each of subjects, resources, actions, groups of subjects, groups of resources, groups of actions, and privileges.

The generated graph has a plurality of nodes, where each node can be one of the following: 1) a subject node that represents a subject from the provided selected subset of subjects, 2) a subject group node that represents a group of subjects from the provided selected subset of groups of subjects, 3) a resource node that represents a resource from the provided selected subset of resources, 4) a resource group node that represents a group of resources from the provided selected subset of groups of resources.

The generated graph also has a plurality of edges that connect between source nodes and destination nodes. Each edge in the generated graph can be one of the following: 1) an edge from a subject node to a subject group node, where such an edge exists if the subject represented by the source node is a member of the group of subjects represented by the destination node, 2) an edge from a resource group node to a resource node, where such an edge exists if the resource represented by the destination node is a member of the group of resources represented by the source node, 3) an edge from a resource node to a subject node, where such an edge exists if there is at least one activity log in the selected subset of activity logs that represents an activity performed by the subject (represented by the destination node) on the resource (represented by the source node), and 4) an edge from a subject node or a subject group node to a resource node or to a resource group node, where such an edge exists if there exists at least one privilege in the selected subset of privileges such that: a) the source node is a member of the set of subjects and groups of subjects associated with the privilege, and b) the destination node is a member of the set of resources and groups of resources associated with the privilege.

The aforementioned graph generated by the graph generation module 30 is referred to interchangeably hereinafter as a “relationship graph”.

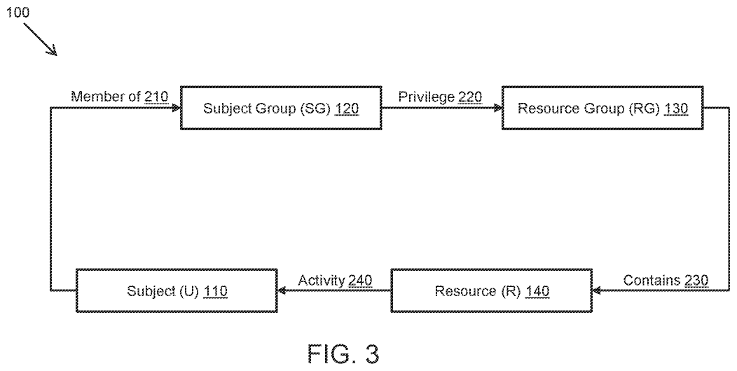

In order to better illustrate the nodes and edges of the relationship graphs that can be generated by the graph generation module 30, attention is directed to FIG. 3, which illustrates a simplified non-limiting example of a relationship graph 100 that can be generated by the graph generation module 30. In the example relationship graph 100, the graph contains the following plurality of nodes: 1) Subject (U) 110, which is a node that represents a subject, for example user U, 2) Subject Group (SG) 120, which is a node that represents a group of subjects (designated SG) that contains user U (i.e., user U is a member of SG), 3) Resource (R) 140, which is a node that represents a resource, and 4) Resource Group (RG) 130, which is a node that represents a group of resources (designated RG) that contains Resource R (i.e., Resource R is a member of RG).

The relationship graph 100 also includes the following plurality of edges: 1) Edge 210 drawn from the source node Subject (U) 110 to the destination node Subject Group (SG) 120 representing that the user U is a member of the subject group SG, 2) Edge 220 drawn from the source node Subject Group (SG) 120 to the destination node Resource Group (RG) 130 representing that there exists a privilege in which Subject Group (SG) 120 is a member of the set of subjects and groups of subjects associated with the privilege and in which Resource Group (RG) 130 is a member of the set of resources and resource groups associated with the privilege, 3) Edge 230 drawn from the source node Resource Group (RG) 130 to the destination node Resource (R) 140 representing that the RG contains R (R is a member of RG), and 4) Edge 240 drawn from source node Resource (R) 140 to Subject (U) 110 representing that there exists at least one activity performed by Subject (U) 110 on the Resource (R) 140.

It is noted that in the example graph 100, there are no direct edges connecting between Subject (U) 110 to Resource Group (RG) 130 because there does not exist any privilege that directly allows Subject (U) 110 to operate on Resource Group (RG) 130. It is further noted that the existence of a path, via one or more edges, from a subject to a resource implies that the subject has permission (i.e., is permitted) to perform an action on that resource. In the example graph 100, Subject (U) 110 is permitted to perform an action on Resource (R) 140.

It is a particular feature of embodiments of the present disclosure to use the relationship graph (generated by the graph generation module 30) to solve a multi-commodity variant of the circulation problem in order to modify, and preferably improve, the security posture of the organization with which the subjects, resources, actions, groups of subjects, groups of resources, groups of actions, and privileges are associated.

By way of introduction, the circulation problem and variants thereof belong to a well-known class of problems in graph theory. In this framework, for a graph G having vertices V and edges E (denoted as G(V,E)), each edge, denoted (v,w), that connects two nodes, denoted as nodes ν and w, is assigned a lower bound, denoted L (v,w), and an upper bound, denoted U(v,w). A solution to the circulation problem is an assignment of a flow value, denoted F (v,w), for the edge (v,w), that upholds the following two constraints: 1) L (v,w)≤F (v,w)≤U (v,w), and 2) for each node ν the sum of the flows on edges leading from node ν is equal to the sum of the flows on edges leading into node ν (this second constraint is known as the “conservation constraint”).

In certain scenarios, more than one solution may exist that upholds the two aforementioned constraints. A solution is considered to be a minimal solution if the sum of F(v,w) over all edges (v,w) is the smallest out of all the potential solutions.

One variant of the circulation problem is the multi-commodity variant, in which multiple commodities exist. One example of commodities in the context of the present disclosure are different types of actions that can be performed on resources. A solution to the multi-commodity variant of the circulation problem is an assignment of a value Fᵢ(v,w) for each commodity i and for each edge (v,w) that upholds the following two constraints: 1) Lᵢ(v,w)≤Fᵢ(v,w)≤Uᵢ(v,w), where Lᵢ(v,w) and Uᵢ (v,w) are respectively the lower and upper bounds for the commodity i on the edge (v,w), and 2) the conservation constraint is upheld individually for each commodity i.

As with the general circulation problem, in certain scenarios more than one solution to the multi-commodity variant that upholds all of the constraints may exist. A solution to the multi-commodity variant of the circulation problem is considered to be a minimal solution if the sum of Fᵢ(v,w) over all edges (v,w) and commodities is the smallest out of all the potential solutions.

Another variant of the circulation problem is the minimum cost variant, in which each edge is also assigned a cost, denoted C(v,w), of a unit of a flow on edge (v,w). The solution to the minimum cost variant is one that minimizes the sum of the product C(v,w)×F(v,w) over all edges (v,w), i.e., one that minimizes Σ_{(v,w)∈E}C(v,w)× F(v,w).

The minimum cost variant can be combined with the multi-commodity variant.

There are various approaches to solving the multi-commodity variant of the circulation problem that are well-known in the art. Prevalent methods rely on modifications of integer linear programming enhanced with Lagrangian relaxation on the flow constraints. One example can be found in a journal article by Weibin Dai, Jun Zhang, and Xiaoqian Sun, entitled “On solving multi-commodity flow problems: An experimental evaluation”, in the Chinese Journal of Aeronautics 30.4 (2017): 1481-1492.

With respect to implementations for solving the circulation problem and its variants, both exact and approximate solutions are available. In the context of the embodiments of the present disclosure, the circulation problem for the generated relationship graph that is to be solved is generally sparse in the sense that there are typically not many paths between node A (e.g., a subject) and node B (e.g., a resource) of the relationship graph. The sparsity of the problem allows for approximate methods to converge to the exact solution easily (with reduced computational complexity compared to exact solvers). However, exact solvers can also be used in situations in which the organization under analysis requires as such.

Bearing in mind the above introduction to the circulation problem and its variants, embodiments of the present disclosure use the relationship graph (generated by the graph generation module 30) to solve a multi-commodity variant of the circulation problem, where each action is a commodity. In particular, according to certain embodiments, edges of the generated relationship graph are assigned upper and lower bounds. The assignment of the upper and lower bounds is preferably as follows:

1) For edges from subjects to subject groups:
a) a lower bound of 0, regardless of the action,
b) an upper bound of infinity, regardless of the action;

2) For edges from subjects and subject groups to resource groups and resources:
a) a lower bound of 0, regardless of the action,
b) an upper bound of infinity for each action for which there exists a privilege that allows the subject or subject groups to perform the action on the resource of resource group;

3) For edges from resource groups to resources:
a) a lower bound of 0, regardless of the action,
b) an upper bound of infinity, regardless of the action;

4) For edges from resources to subjects:
a) for an action for which there exists at least one activity in which the subject performed the action on the resource:
   i) a positive (non-zero) lower bound representing one of the following:
      A) a fixed positive number, e.g., 1,
      B) the number of activities that match the subject, action, and resource of the edge,
      C) a weighted sum of the activities that match the subject, action, and resource of the edge, such that the weight is computed using exponential decay based on the time at which the activity occurred,
      D) a weighted sum of the activities that match the subject, action, and resource of the edge, such that the weight is computed using a linear function based on the time at which the activity occurred,
   ii) an upper bound of infinity,
b) for all other actions:
   i) a lower bound of 0,
   ii) an upper bound of 0.

It is noted that in the above lower and upper bound assignments, a lower bound of 0 is effectively equivalent to not having a lower bound at all, and an upper bound of infinity is effectively equivalent to not having an upper bound at all.

The constraint application module 32 functions to apply a set of circulation problem constraints, in particular the aforementioned constraints, to the relationship graph (produced by the graph generation module 30) so as to produce (generate) a constrained relationship graph. The constrained relationship graph enables the organization to modify its security posture based on the constrained relationship graph. In particular, the constrained relationship graph is used by the system 10 in order to improve the security posture of the organization, as will be discussed in further detail below.

In certain embodiments, the constraint application module 32 further functions to assign a cost to each edge. In particular, edges from subjects to resources or to resource groups can be assigned a higher cost than the costs associated with edges from subject groups to resource groups. Thus, solutions that minimize the overall cost will tend to favor privileges through general roles.

The identification module 34 functions to receive a constrained relationship graph as input, and to identify various features of the constrained relationship graph, and in particular one or more sets of edges in the constrained relationship graph having certain characteristics.

In certain embodiments, the identification module 34 functions to identify edges of the constrained relationship graph that have a characteristic of being critical or not critical (i.e., non-critical) edges. In certain embodiments, the identification module 34 functions to classify edges as critical or non-critical in order to perform the aforementioned identification. Generally speaking, an edge is considered to be a critical edge in such a constrained graph if, after removal of such a critical edge, a solution to the circulation problem no longer exists. An edge is considered to be non-critical if it is not a critical edge.

In the context of the embodiments of the present disclosure, there is a value in performing critical/non-critical classification for all edges that do not represent activities. For example, if an edge from a subject node to a subject group node is classified by the identification module 34 as a critical edge, removal of that critical edge would likely prevent future activities from taking place. A user that attempts to affect a change to one of the directories 18 that will result in removal of such a critical edge would benefit from being warned or prompted that such a change may result in preventing likely legitimate activities from occurring. Such a warning or prompt can be provided to the user via the output module 44, or via the UI 46.

As another example, removal of a non-critical edge that represents a privilege is likely to not affect future legitimate activities and would likely improve the security posture of the organization.

In certain embodiments, the output module 44 or via the UI 46 provides as output a list of non-critical edges, including edges that represent privileges. Providing such non-critical edges could allow an organization to consider options of removing one or more of the non-critical edges in the list in order to improve the security posture of the organization, while also reducing the overhead and administrative costs for managing the organization.

According to certain embodiments of the present disclosure, the identification module 34 functions to identify flow-related characteristics of the constrained relationship graph, including aggregate flow. Generally speaking, given a solution to the multi-commodity variant of the circulation problem for a relationship graph (i.e., given a constrained relationship graph), the aggregate flow over an edge of the graph is the sum of the flows over the edge across all actions. In certain preferred embodiments, the identification module 34 functions to identify: 1) edges from subjects to subject groups whose aggregate flow is high, 2) edges from subjects to subject groups whose aggregate flow is low, 3) edges from resource groups to resources whose aggregate flow is high, 4) edges from resource groups to resources whose aggregate flow is low, 5) edges from subjects or subject groups to resource groups or resources whose flow is high, and 6) edges from subjects or subject groups to resource groups or resources whose flow is low.

A flow or an aggregated flow is considered to be “high” if the flow or aggregated flow is above a threshold, for example a predefined absolute value and/or a predefined relative value, compared to the total flows across all edges. Similarly, a flow or aggregated flow is considered to be “low” if the flow or aggregated flow is below a threshold, for example a predefined absolute value and/or a predefined relative value, compared to the total flows across all edges.

Edges having a flow or aggregated flow, whichever the case may be, that is considered “high” represent a relationship within the organization whose existence underlies many activities and as such should not be severed (i.e. such edges should not be removed). Similarly, edges having a flow or aggregated flow, whichever the case may be, that is considered “low” represent a relationship within the organization which is underutilized and as such may not be needed.

In certain preferred embodiments, the identification module 34 further functions to provide the identified edges as output to a user of the system 10. In one example, the identification module 34 provides the identified edges to the output module 44 or to the UI 46, which output the identified edges to the user of the system 10.

According to certain embodiments of the present disclosure, the community detection module 38 functions to receive as input a graph, and to perform community detection on the nodes of the received graph to identify one or more communities of similar nodes (e.g., similar subjects, similar groups of subjects, similar resources, similar groups of resources). For each identified community, the nodes in the identified community are all of the same node type, i.e., the nodes in an identified community are all subject nodes, or are all subject group nodes, or are all resource nodes, or are all subject group nodes. In one example, the community detection module 38 can apply one or more community detection algorithms to identify one or more communities of similar subjects (e.g., users) and/or groups of subjects based on the fact that the similar users and/or groups of users all share edges with the same set of nodes. Alternatively, or in addition, the community detection module 38 can apply one or more community detection algorithms to identify one or more communities of similar resources and/or groups of resources based on the fact that the similar resources and/or groups of resources all share edges with the same set of nodes. The community detection module 38 can apply the community detection algorithm or algorithms to perform community detection of the nodes of the constrained relationship graph, or of the nodes of a filtered graph that is a filtered version of the constrained relationship graph. The community detection module 38 can execute any suitable community detection algorithm, including, for example, Louvain community detection, LPA (label propagation algorithm), and the like.

In certain preferred embodiments, the community detection module 38 further functions to provide the identified communities of similar nodes as output to a user of the system 10. In one example, the community detection module 38 provides the identified communities to the output module 44 or to the UI 46, which output the identified communities to the user of the system 10.

In certain embodiments of the present disclosure, the centrality measurement module 40 functions to receive as input a graph, and to perform centrality measurement of the nodes of the received graph to identify one or more nodes that are deemed central. For example, the centrality measurement module 40 can apply one or more centrality measurement algorithms to identify one or more resources and/or one or more groups of resources that are deemed central based on the number of edges leading to or from resources and/or groups of resource and that are in extensive use. Alternatively, or in addition, the centrality measurement module 40 can apply one or more centrality measurement algorithms to identify one or more subjects and/or one or more groups of subjects that are deemed central based on the number of edges leading to or from subjects and/or groups of subjects and that are in extensive use The centrality measurement module 40 can apply the centrality measurement algorithm or algorithms to perform centrality measurement of the nodes of the constrained relationship graph, or of the nodes of a filtered graph that is a filtered version of the constrained relationship graph. The centrality measurement module 40 can execute any suitable centrality measurement algorithm, including, for example, Betweenness centrality, Eigenvector centrality, PageRank algorithm, and the like.

In certain preferred embodiments, the centrality measurement module 40 further functions to provide the identified central nodes (resources, groups of resources, subjects, groups of subjects) as output to a user of the system 10. In one example, the centrality measurement module 40 provides the identified central nodes to the output module 44 or to the UI 46, which output the identified central nodes to the user of the system 10.

As mentioned, the community detection module 38 and the centrality measurement module 40 can function to operate on the constrained relationship graph, or on a filtered graph. In certain embodiments, the filter module 36 is used by the system 10 to obtain the filtered graph. In particular, the filter module 36 functions to receive as input a constrained relationship graph, and produce a filtered graph, which is a filtered version of the constrained relationship graph, as output. The filter module 36 produces the filtered graph by filtering out edges of the constrained relationship graph that have an aggregated flow that is below a preconfigured threshold.

According to certain embodiments of the present disclosure, the path identification module 42 functions to receive as input a subject or group of subjects, a resource or group of resources, and a set of one or more actions, and identifies multiple paths on the graph (the constrained relationship graph or the filtered graph) that lead from the same subject or group of subjects to the same resource or group of resources and that allow the same set of actions. In such a case, the path identification module 42 further functions to output the identified set of paths or the edges of the paths. The path identification module 42 may, in certain embodiments, provide the identified set of paths or the edges of the paths as output in a sorted manner, specifically by sorting the identified set of paths or the edges of the paths according to the aggregate flows across the set of actions on the edges. It should be appreciated that providing such output could be useful in trimming redundant permissions with preference given to trimming edges having a “low” aggregate flow.

In certain embodiments, the path identification module 42 can provide the identified set of paths or the edges of the paths (sorted or unsorted) to the output module 44 or to the UI 46, which output the identified set of paths or the edges of the paths to the user of the system 10.

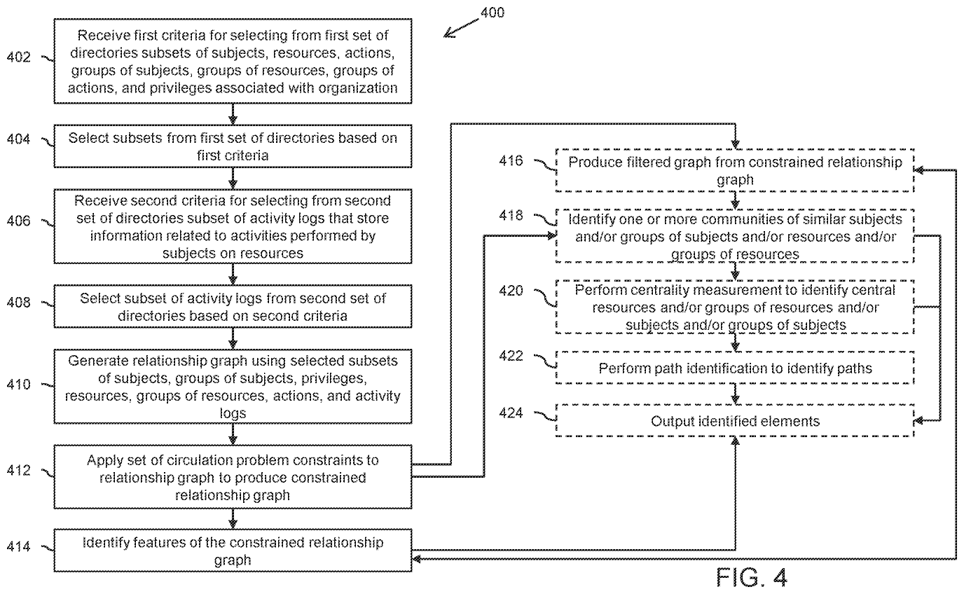

Attention is now directed to FIG. 4 which shows a flow diagram illustrating a computer-implemented (i.e., a computerized) process 400 in accordance with embodiments of the disclosed subject matter. This computer-implemented process provides steps for generating and utilizing constrained graphs in order modify, and in particular to improve, the security posture of an organization/enterprise. Reference is also made to FIGS. 1-3 and the components illustrated therein. The process and sub-processes of FIG. 4 are computerized processes that operate on data objects and are performed by components of the system 10, including, for example, the CPU 12 and associated components, such as the criteria receiving modules 22, 24, the selection modules 26, 28, the graph generation module 30, the constraint application module 32, the identification module 34, the filter module 36, the community detection module 38, the centrality measurement module 40, the path identification module 42, the output module 44, and the UI 46. The aforementioned processes and sub-processes are for example, performed automatically by the system 10, and are performed, for example, in real-time.

The process 400 begins at block 402, where the first criteria receiving module 22 receives a set of first criteria for selecting, from a first set of one or more directories 18 that store information about subjects, resources, actions, and privileges associated with an organization, subsets of each of subjects, resources, actions, groups of subjects, groups of resources, groups of actions, and privileges associated with the organization. At step 404, the first selection module 24 selects the subsets from the first set of directories 18 based on the set of first selection criteria. Each subset (selected by the first selection module 24) is a data object that contains data/information that is descriptive of the element associated with the subset. For example, the subset of subjects is a data object that contains data/information that is descriptive of the subjects in the subset of subjects.

At step 406, the second criteria receiving module 26 receives a set of second criteria for selecting, from a second set of one or more directories 18 that store activity logs that store information related to activities performed by subjects on resources, a subset of activity logs. At step 408, the second selection module 28 selects the subset of activity logs from the second set of directories 18 based on the set of second selection criteria.

It is noted that steps 402 and 406 can be performed in parallel, or in a reverse order from that which is illustrated in FIG. 4.

The process 400 then moves to step 410, where the graph generation module 30 generates a relationship graph using the selected subsets of subjects, groups of subjects, privileges, resources, groups of resources, actions, and activity logs (selected by the selection modules 24, 28 at steps 404, 408). At step 412, the constraint application module 32 applies a set of circulation problem constraints to the relationship graph (generated at step 410) to produce a constrained relationship graph.

At step 414, the identification module 34 identifies various features of the constrained relationship graph, including one or more of: 1) identification of edges of the constrained relationship graph that have a characteristic of being critical or non-critical edges, and 2) flow-related characteristics of the constrained relationship graph, as described above. From step 414, the process 400 may move to step 424, where the identified features are provided as output, for example via the output module 44 or the UI 46.

At optional step 416, the filter module 36 produces a filtered graph, which is a filtered version of the constrained relationship graph, for example by filtering out edges of the constrained relationship graph that have an aggregated flow that is below a preconfigured threshold. Step 416 can be executed in parallel with step 414, or can be executed after step 416. Step 414 may alternatively be executed after step 416, i.e., the identification module 34 can identify one or more of the aforementioned various features in the filtered graph.

From steps 412 or 416, steps 418, 420, 422 can be performed. Although steps 418, 420, 422 are shown in FIG. 4 as being performed in a sequential order, these steps 418, 420, 422 can be performed in any order. Furthermore, these steps 418, 420, 422 are optional, such that none, some, or all of the steps 418, 420, 422 can be performed.

At step 418, the community detection module 38 performs community detection on the nodes of the constrained relationship graph or the filtered graph to identify one or more communities of similar nodes (e.g., similar subjects (for example users), and/or similar groups of subjects, and/or similar resources, and/or similar groups of resources). At step 420, the centrality measurement module 40 performs centrality measurement of the nodes of the constrained relationship graph or the filtered graph to identify one or more nodes (e.g., resources, and/or groups of resource, and/or subjects, and/or groups of subjects) that are deemed central. At step 422, the path identification module 42 identifies multiple paths on the constrained relationship graph or the filtered graph that lead from the same subject or group of subjects to the same resource or group of resources and that allow the same set of actions.

From each of steps 418, 420, 422, the process 400 can proceed to step 424, where the elements identified at any of steps 418, 420, 422 are output, for example by the output module 44 or the UI 46. As mentioned above, the process 400 can also move to step 424 from step 414.

It is noted that the elements that are output at step 424 can be provided as output in order to be viewed by a user of the system 10, such as a system administrator, such that the user/administrator can interact with the system 10 (e.g., via the UI 46) in order to affect changes, or refrain from affecting changes, that will modify the security posture of the organization. For example, as a result of step 414, the identification module 34 may provide as output to the system administrator a list of critical and non-critical edges of the constrained relationship graph. The administrator may then improve the security posture for example by manually removing the non-critical edges (for example by modifying relevant information in the relevant set of directories 18). As another example, if the administrator attempts to affect a change to one of the directories 18 that will result in removal of a critical edge, the output module 44 or UI 46 can provide a warning to the administrator that applying such a change may result in preventing likely legitimate activities from occurring.

It should be appreciated that the functions performed at steps 414, 416 418, 420, 422 are merely examples of some of the ways that the various generated graphs according to the embodiments disclosed herein can be used. Those of skill in the art will appreciate that any of the aforementioned graphs can be used in other ways, some of which can further improve the security posture of an organization. As one additional example, the graphs can be used to remove unutilized access to resources or groups of resources by removing edges having no circulation. As a further additional example, the risk of over-granting access or failing to remove access can be reduced by optimizing the graph (the constrained relationship graph) to maximize flow, for example by removing parallel edges (which divide flow), thereby further improving the security posture of the organization.

As should now be apparent from the description above, the embodiments of the methods and systems according to present disclosure provide improvements in computer security policy and/or computer-based access control policy employed by an organization/enterprise, and solve a particular problem of how to manage complex security policies and/or access control policies by utilizing the above-described graphs to identify redundancy in such policies and to generalize such policies. In addition, the problems that are solved by the embodiments of the present disclosure are high-complexity problems, typically having overly large input sets, and which cannot be practically solved without the use of a computer or computer system. This is particularly true in situations in which the organization/enterprise utilizing the disclosed embodiments has several tens, hundreds, thousands of subjects (which may continue to grow) and several tens, hundreds, thousands of electronic resources (which may also continue to grow), whereby attempting to manage the complex relationships between resources and subjects (and groups thereof) using the methods disclosed herein without the use of a computer or computer system is wholly impracticable.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. A non-transitory computer readable (storage) medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the accompanying drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A computer-implemented method comprising:
based on received first criteria, selecting from one or more first set of computerized directories that store information about subjects, resources, actions, and privileges associated with an organization, subsets of each of: i) subjects, ii) groups of subjects, iii) privileges, iv) resources, v) groups of resources, and vi) actions;
based on received second criteria, selecting from one or more second set of directories a subset of activity logs that store information related to activities performed by subjects on resources;
generating a relationship graph using the selected subsets of i) subjects, ii) groups of subjects, iii) privileges, iv) resources, v) groups of resources, vi) actions, and vii) activity logs; and
applying a set of circulation problem constraints to the relationship graph to produce a constrained relationship graph so as to enable the organization to modify a security posture based on the constrained relationship graph.

2. The computer-implemented method of claim 1, further comprising:
identifying in the constrained relationship graph one or more sets of edges that have at least one of the following characteristics: i) are critical edges, ii) are non-critical edges, iii) have a high aggregate flow, iv) have a low aggregate flow, v) have a high flow, or vi) have a low flow.

3. The computer-implemented method of claim 1, further comprising:
applying a community detection algorithm to the constrained relationship graph to identify one or more communities of similar nodes that share one or more edges of the constrained relationship graph with a same set of nodes of the constrained relationship graph, wherein for each identified community of the identified one or more communities, the nodes in the identified community are all of a same node type that is selected from the group consisting of: subjects, groups of subjects, resources, and groups of resources; and
outputting the identified one or more communities.

4. The computer-implemented method of claim 1, further comprising:
applying a centrality measurement algorithm to the constrained relationship graph to identify one or more nodes as central nodes based on a number of edges leading to or from the identified one or more nodes, wherein the identified one or more central nodes includes one or more: resources, groups of resources, subjects, or groups of subjects; and
outputting the identified one or more central nodes.

5. The computer-implemented method of claim 1, further comprising:
filtering out edges of the constrained relationship graph that have an aggregated flow that is below a preconfigured threshold to obtain a filtered graph.

6. The computer-implemented method of claim 5, further comprising:
applying a community detection algorithm to the filtered graph to identify one or more communities of similar nodes that share one or more edges of the filtered graph with a same set of nodes of the filtered graph, wherein for each identified community of the identified one or more communities, the nodes in the identified community are all of a same node type that is selected from the group consisting of: subjects, groups of subjects, resources, and groups of resources; and
outputting the identified one or more communities.

7. The computer-implemented method of claim 1, further comprising:
applying a centrality measurement algorithm to the filtered graph to identify one or more nodes as central nodes based on a number of edges leading to or from the identified one or more nodes, wherein the identified one or more central nodes includes one or more: resources, groups of resources, subjects, or groups of subjects; and
outputting the identified one or more central nodes.

8. A computer system comprising:
a non-transitory computer readable storage medium for storing computer components; and
a processor for executing the computer components comprising:
a first selection module for selecting, from one or more first set of computerized directories that store information about subjects, resources, actions, and privileges associated with an organization, subsets of each of: i) subjects, ii) groups of subjects, iii) privileges, iv) resources, v) groups of resources, and vi) actions, wherein the first selection module performs the selecting based on received first criteria,
a second selection module for selecting from one or more second set of directories, and based on received second criteria, a subset of activity logs that store information related to activities performed by subjects on resources,
a graph generation module for generating a relationship graph using the selected subsets of i) subjects, ii) groups of subjects, iii) privileges, iv) resources, v) groups of resources, vi) actions, and vii) activity logs, and
a constraint application module for applying a set of circulation problem constraints to the relationship graph to produce a constrained relationship graph so as to enable the organization to modify a security posture based on the constrained relationship graph.

9. The computer system of claim 8, the computer components further comprising:
an identification module for identifying in the constrained relationship graph one or more sets of edges that have at least one of the following characteristics: i) are critical edges, ii) are non-critical edges, iii) have a high aggregate flow, iv) have a low aggregate flow, v) have a high flow, or vi) have a low flow.

10. The computer system of claim 8, the computer components further comprising:
a community detection module for:
applying a community detection algorithm to the constrained relationship graph to identify one or more communities of similar nodes that share one or more edges of the constrained relationship graph with a same set of nodes of the constrained relationship graph, wherein for each identified community of the identified one or more communities, the nodes in the identified community are all of a same node type that is selected from the group consisting of: subjects, groups of subjects, resources, and groups of resources, and
providing the identified one or more communities for output.

11. The computer system of claim 8, the computer components further comprising:
a centrality measurement module for:
applying a centrality measurement algorithm to the constrained relationship graph to identify one or more nodes as central nodes based on a number of edges leading to or from the identified one or more nodes, wherein the identified one or more central nodes includes one or more: resources, groups of resources, subjects, or groups of subjects, and
providing the identified one or more central nodes as output.

12. The computer system of claim 8, the computer components further comprising:
a filter module for filtering out edges of the constrained relationship graph that have an aggregated flow that is below a preconfigured threshold to obtain a filtered graph.

13. The computer system of claim 12, the computer components further comprising:
a community detection module for:
applying a community detection algorithm to the filtered graph to identify one or more communities of similar nodes that share one or more edges of the filtered graph with a same set of nodes of the filtered graph, wherein for each identified community of the identified one or more communities, the nodes in the identified community are all of a same node type that is selected from the group consisting of: subjects, groups of subjects, resources, and groups of resources, and
providing the identified one or more communities for output.

14. The computer system of claim 12, the computer components further comprising:
a centrality measurement module for:
applying a centrality measurement algorithm to the filtered graph to identify one or more nodes as central nodes based on a number of edges leading to or from the identified one or more nodes, wherein the identified one or more central nodes includes one or more: resources, groups of resources, subjects, or groups of subjects, and
providing the identified one or more central nodes as output.

15. A computer usable non-transitory storage medium having a computer program embodied thereon for causing a suitable programmed system to perform the following steps when such program is executed on the system, the steps comprising:
based on received first criteria, selecting from one or more first set of computerized directories that store information about subjects, resources, actions, and privileges associated with an organization, subsets of each of: i) subjects, ii) groups of subjects, iii) privileges, iv) resources, v) groups of resources, and vi) actions;
based on received second criteria, selecting from one or more second set of directories a subset of activity logs that store information related to activities performed by subjects on resources;
generating a relationship graph using the selected subsets of i) subjects, ii) groups of subjects, iii) privileges, iv) resources, v) groups of resources, vi) actions, and vii) activity logs; and
applying a set of circulation problem constraints to the relationship graph to produce a constrained relationship graph so as to enable the organization to modify a security posture based on the constrained relationship graph.

16. The computer usable non-transitory storage medium of claim 15, the steps further comprising:
identifying in the constrained relationship graph one or more sets of edges that have at least one of the following characteristics: i) are critical edges, ii) are non-critical edges, iii) have a high aggregate flow, iv) have a low aggregate flow, v) have a high flow, or vi) have a low flow.

17. The computer usable non-transitory storage medium of claim 15, the steps further comprising:
applying a community detection algorithm to the constrained relationship graph to identify one or more communities of similar nodes that share one or more edges of the constrained relationship graph with a same set of nodes of the constrained relationship graph, wherein for each identified community of the identified one or more communities, the nodes in the identified community are all of a same node type that is selected from the group consisting of: subjects, groups of subjects, resources, and groups of resources; and
outputting the identified one or more communities.

18. The computer usable non-transitory storage medium of claim 15, the steps further comprising:
applying a centrality measurement algorithm to the constrained relationship graph to identify one or more nodes as central nodes based on a number of edges leading to or from the identified one or more nodes, wherein the identified one or more central nodes includes one or more: resources, groups of resources, subjects, or groups of subjects; and
outputting the identified one or more central nodes.

19. The computer usable non-transitory storage medium of claim 15, the steps further comprising:
filtering out edges of the constrained relationship graph that have an aggregated flow that is below a preconfigured threshold to obtain a filtered graph.

20. The computer usable non-transitory storage medium of claim 19, the steps further comprising:
applying a community detection algorithm to the filtered graph to identify one or more communities of similar nodes that share one or more edges of the filtered graph with a same set of nodes of the filtered graph, wherein for each identified community of the identified one or more communities, the nodes in the identified community are all of a same node type that is selected from the group consisting of: subjects, groups of subjects, resources, and groups of resources; and
outputting the identified one or more communities.

21. The computer usable non-transitory storage medium of claim 19, the steps further comprising:
applying a centrality measurement algorithm to the filtered graph to identify one or more nodes as central nodes based on a number of edges leading to or from the identified one or more nodes, wherein the identified one or more central nodes includes one or more: resources, groups of resources, subjects, or groups of subjects; and
outputting the identified one or more central nodes.
